(19) United States
(12) Patent Application Publication
(10) Pub. No.: US 2026/0074233 A1
(43) Pub. Date: Mar. 12, 2026

(54) Electrode for an Electrochemical Storage Cell, Electrochemical Storage Cell and Method of Producing an Electrode

(71) Applicant: Bayerische Motoren Werke Aktiengesellschaft, Muenchen (DE)

(72) Inventors: Manfred RAPP, Forstinning (DE); Hyunchul ROH, Muenchen (DE); Nina ZENSEN, Pfaffenhofen an der llm (DE)

(21) Appl. No.: 19/107,670

(22) PCT Filed: Aug. 25, 2023
(86) PCT No.: PCT/EP2023/073372

§ 371 Date: Feb. 28, 2025

(30) Foreign Application Priority Data
Sep. 2, 2022 (DE) 10 2022 122 308.6

(51) Int. Cl. H01M 4/66; H01M 4/04; H01M 4/75; H01M 10/0525

(52) U.S. Cl. CPC H01M 4/667; H01M 4/0404; H01M 4/663; H01M 4/664; H01M 4/668; H01M 4/75; H01M 10/0525

(57) ABSTRACT

Electrodes for an electrochemical storage cell, including a conductor foil including an application zone for an electrode coating, the application zone including an outer region and a central region, are provided. The outer region of the application zone lies closer to an outer edge of the conductor foil than the central region. The application zone, in the outer region, has at least one electrolyte conduction region in which the diffusion rate of an electrolyte of the electrochemical storage cell is higher than in the application zone outside the electrolyte conduction region. Electrochemical storage cells including at least one electrode are further provided. Processes for producing an electrode for an electrochemical storage cell are further provided.

### BACKGROUND AND SUMMARY

The present disclosure relates to an electrode for an electrochemical storage cell, to an electrochemical storage cell comprising such an electrode, and to a process for producing an electrode.

An electrochemical storage cell is an electrochemical-based energy storage medium which is rechargeable in particular and is adapted to store electrical energy and to provide it to consumers, for example consumers in a vehicle.

Crucial factors for the performance of an electrochemical storage cell are the achievable energy density, the lifetime, and the charge and discharge rate available, which is of particular significance in vehicle applications in particular and should be as high as possible. However, the available charge and discharge rate is limited by various effects, including the expected temperature evolution during the charging and discharging operation and aging effects.

An electrochemical storage cell has at least two different electrodes: a positive electrode (cathode) and a negative electrode (anode). Each of these electrodes has at least one active material, optionally together with additions such as electrode binders and electrical conductivity additives that are applied to an electrically conductive carrier of the respective electrodes. Electrically conductive carriers used are in particular solid, nonporous and solid conductor foils of aluminum (for the positive electrode) or copper (for the negative electrode), which are also known by the term “solid foils” in the technical jargon. Such conductor foils are impervious to gases and liquid electrolyte.

For use in the electrochemical storage cell, the electrodes are especially in the form of an electrode winding (also referred to as “jelly roll”), where a separator for electrical insulation is disposed between each cathode and anode.

In the process for production of the electrochemical storage cell, it is necessary to soak the electrode winding with electrolyte after introduction into a housing, and a certain contact time is needed in order to assure sufficient and uniform wetting of the internal porosity of the electrodes up to the interface.

It has been found here that complete wetting is often unachievable in known electrochemical storage cells. Particularly in the center of the electrochemical storage cell, it can be observed that this remains essentially dry in the worst case. However, regions of the electrical storage cell that have not been soaked by electrolyte cannot take part in charging and discharging cycles, and so performance is limited.

In order to counteract this effect, it is known that the contact time of the electrolyte can be extended, the electrolyte can be introduced under the influence of a reduced pressure, the composition of the electrolyte can be varied such that it is more mobile and/or pores can be provided within the electrodes of the electrochemical storage cell. A common factor to all these solutions is that they are complex, restrict freedom of formulation and/or excessively lower the energy density of the electrochemical energy storage means.

It is an object of the present disclosure to specify improving the wetting characteristics of electrochemical storage cells.

The object is achieved in accordance with the present disclosure by an electrode for an electrochemical storage cell, having a conductor foil comprising an application zone for an electrode coating comprising an outer region and a central region. The outer region of the application zone lies closer to an outer edge of the conductor foil than the central region of the application zone. The electrode coating, in the outer region has at least one electrolyte conduction region in which the diffusion rate of an electrolyte of the electrochemical storage cell is higher than in the electrode coating outside the electrolyte conduction region.

The outer edge is that edge of the conductor foil that runs parallel to a longitudinal direction of the conductor foil along which the conductor foil—and hence the electrode as well—is rolled up when the electrode is processed to an electrode winding or jelly roll.

The basic concept of the present disclosure is that of increasing the wettability of the electrode by specifically introducing electrolyte conduction regions into the electrode coating that permit faster diffusion of the electrolyte along these electrolyte conduction regions than outside these regions. In effect, “electrolyte highways” are introduced within the electrode coating.

Improved wettability of the electrode of the present disclosure can be shown by comparison with a conventional electrode coating. For this purpose, two cells having the same electrode design, in other words the same length and the same electrode coating, are filled with an electrolyte of the same composition. The difference between the cells is thus merely that the conventional electrode has been produced without the electrolyte conduction regions of the present disclosure. A difference in the diffusion rate of the electrolyte may be shown either by a stable or fluctuating, in other words still rising, open-circuit voltage (OCV). By opening the cell, it is possible in the conventional cell to find a difference by virtue of different-colored regions on the electrode or even local plating.

Outside an active cell, the dry comparative electrodes may be placed by the lower coating edge into a glass containing electrolyte or a comparable liquid as eluent, to which may be added a colorant or contrast agent, for example. In this case, the eluent front of the electrolyte moves with different speed. If the migration of the eluent is not visually detectable, the comparative electrodes can be subjected to further tests. For example, it is possible by EDX analysis to detect the extent to which a particular solid added to the electrolyte or eluent has migrated after a given time. For EDX analyses, the liquid components of the eluent are evaporated, while the added solid matter remains in the electrode.

The electrolyte conduction regions are provided in regions of the electrode coating that are assigned to a top side or bottom side of the electrode winding in the later installation position of the electrode, meaning those regions that can be reliably supplied with electrolyte. In the case of the top side of the electrode winding, this is done by typically introducing the electrolyte via an introduction opening from the top into a storage housing of the electrochemical storage cell, while the bottom side is supplied with electrolyte in that the electrolyte flows downward under gravity between the electrode winding and a lateral face of the housing.

The configuration of the electrode of the present disclosure ensures that, firstly, the diffusion rate of the electrolyte is influenced and hence optimal wetting even of the central region of the electrode coating is enabled, and, secondly, the energy density of an electrochemical storage cell having an electrode of the present disclosure is not excessively reduced since adaptations to the electrode coating are needed only in the electrolyte conduction region. An optimal compromise is thus enabled between wettability and energy density.

The electrolyte conduction region may be a sub-region of the outer region. Alternatively, it is also possible for the whole outer region to form the electrolyte conduction region.

The outer region in particular takes up from 10% to 40% of the area of the application zone of the conductor foil, while the rest of the application zone is formed by the central region.

In one configuration, the electrode coating comprises a fiber material in the electrolyte conduction region. The fiber material serves to transport the electrolyte through the electrode coating at or within the fiber material. In other words, the electrolyte is to some extent “pulled through”at the fiber material through the electrolyte conduction region.

The fiber material may comprise or consist of glass fibers and/or cellulose fibers.

It is also possible to use an electrically conductive fiber material. In this way, it is simultaneously possible to influence the electrical properties of the electrode coating via the fiber material. The electrically conductive fiber material used may, for example, be metallized glass fibers or electrically conductive carbon fibers, for example “vapor grown carbon fibers”.

In a further configuration, the electrode coating, in the electrolyte conduction region, comprises a porous material which is absorptive with respect to the electrolyte. In this case, the diffusion rate of the electrolyte is increased by the absorptive action caused by the porous material.

The word “absorptive” here means that the porous material is capable of absorbing electrolyte into pores of the porous material.

The porous material may be a carbon material. In particular, the carbon material is selected from the group consisting of carbon aerogels, mesoporous carbons, macroporous carbons, carbons produced by template synthesis, and combinations thereof.

One example of a suitable carbon material is obtainable under the “Porocarb” name from Heraeus.

The term “mesoporous carbons” here refers to carbon materials having a pore size in the range from 2 to 50 nm, while “macroporous carbons” are those having a pore size above 50 nm.

It is also possible that the carbon material has a hierarchical pore system in which smaller pores having a pore size in the nanometer range are present in the walls of larger pores having a pore size in the micrometer range. For example, the carbon material having a hierarchical pore system is called a “Kroll carbon”.

In yet a further configuration, the electrode coating, in the electrolyte conduction region, has one or more depressions. The depressions offer defined clear spaces at the surface of the electrode coating that can be filled by the electrolyte. In other words, the depressions may serve as a kind of “collecting vessel” for the electrolyte, from which the electrolyte can diffuse into other regions of the electrode coating.

In particular, the depressions have an essentially elongated outline directed from the outer edge of the conductor foil in the direction of the central region. This means that the depressions, especially in this direction (also referred to as widthwise direction), have a greater extent than in a direction parallel to the outer edge (also referred to as longitudinal direction).

For example, the depressions have an extent in widthwise direction that is at least twice as high as the extent in longitudinal direction.

Preferably, at least one of the depressions has an outline that narrows in the direction of the central region of the electrode coating.

In particular, at least one of the depressions may have a symmetrical outline.

The one or more depressions may also extend in the manner of capillaries from the outer edge in the direction of the central region through the outer region of the electrode coating.

In order to provide the depressions in the electrode coating, these may be created by a roller having a structured surface after the electrode coating has been applied to the conductor.

In yet a further configuration, the electrode coating, in the electrolyte conduction region, comprises a pore former set up to be at least partly removable from the electrode coating.

The pore former makes it possible, by the removal of the pore former, for pores to be generatable in a controlled manner in the electrode coating, which can be influenced in terms of their shape, size and position. In this way, particularly precise control is possible via the configuration of the pores generated, in order to achieve an optimal compromise between reduction of the energy density achievable with the electrode and absorption characteristics with respect to the electrolyte.

The pore former may be designed to break down at least partly, especially completely, to gaseous compounds on attainment of a breakdown temperature. In this way, the pore former may be removed from the electrode coating after the breakdown temperature has been attained.

For example, the pore former is ammonium bicarbonate (NH₄HCO₃), which breaks down at a temperature of 60° C. or more.

In particular, the pore former, in the process for producing the electrode and/or an electrochemical storage cell that uses the electrode, may be converted to the gas phase, for example by vacuum drying or evaporation of the pore former. Conversion to the gas phase is thus also possible without chemical conversion within the scope of the present disclosure.

The pore former is preferably simultaneously converted to the gas phase in a process step that occurs in any case in the respective production process, such that no additional steps need be provided for removal of the pore former. The pore former can be removed, for example, in the step of vacuum drying of the electrode prior to assembly of the cell. If this step is conducted, the vacuum drying temperature is >60° C.

If the electrode is produced without vacuum drying, the pore former can also be removed in the step of drying the overall cell.

The object of the present disclosure is also achieved by an electrochemical storage cell comprising at least one electrode as described above.

The features and properties of the electrode of the invention are correspondingly applicable to the electrochemical storage cell and vice versa, and reference is made to the observations above.

The electrochemical storage cell is in particular a lithium ion battery, and so the invention relates in particular to an electrode for a lithium ion battery and to a lithium ion battery comprising such an electrode.

The term “lithium ion battery” is used synonymously for all terms for lithium-containing galvanic elements and cells that are commonly used in the art, for example lithium battery, lithium cell, lithium ion cell, lithium-polymer cell, lithium ion battery cell, and lithium ion accumulator. In particular, rechargeable batteries (secondary batteries) are included. The terms “battery” and “electrochemical cell” are also used synonymously with the terms “lithium ion battery” and “lithium ion cell”.

The use of the electrode of the present disclosure in the electrochemical storage cell of the present disclosure enables substantially complete wetting of an electrode winding of the electrochemical storage cell, while at the same time there is no need to reduce the energy density of the electrochemical storage cell to an unnecessarily high degree.

Improved wetting with electrolyte additionally achieves more uniform evolution of heat in operation of the electrochemical storage cell, which has a favorable effect on the reliability and lifetime of the electrochemical storage cell.

Moreover, the object of the present disclosure is achieved by a process for producing an electrode for an electrochemical storage cell as described above, comprising the applying and/or treating of an electrode coating on an application zone of the conductor foil such that the electrode coating comprises different regions that provide a different diffusion rate for an electrolyte, where the different regions comprise at least one outer region and one central region.

In other words, the process is based on the basic concept of influencing the composition and/or configuration of the electrode coating so as to create regions having different diffusion rates.

In one variant, the composition of the electrode coating is varied in the different regions, in other words, in the outer region and in the central region.

For example, in the outer region, a fiber material, a porous material and/or a pore former is added, or a dose of an adapted electrode coating additionally including this/these component(s) is used.

In order to treat the electrode coating, the electrode coating may be calendered with a roller having a structured roller surface.

The term “structured roller surface” refers to a roller surface having at least one elevation with which a depression can be created in the electrode coating.

It is thus possible, in a calendering step—which typically occurs in any case—in the electrode production, simultaneously also to provide one or more depressions in the outer region of the electrode coating.

Further properties and features of the present disclosure will be apparent from the description of illustrative embodiments that follows, which should not be understood in a limiting sense, and from the drawings. These show:

### BRIEF DESCRIPTION OF THE DRAWINGS

FIG. 1: a schematic of an electrode winding of an electrochemical storage cell comprising an electrode according to a working example,

FIG. 2 to FIG. 4: various embodiments of the electrode from FIG. 1,

FIG. 5 to 7: further embodiments of the electrode from FIG. 1 analogously to FIG. 2 to 4,

FIG. 8: a schematic of a processing step of a first embodiment of a process for producing the electrochemical storage cell from FIG. 1,

FIG. 9: a schematic of an electrode precursor and electrodes as obtainable from the process according to FIG. 8,

FIG. 10: a schematic of a processing step in a second embodiment of a process for producing the electrochemical storage cell from FIG. 1,

FIG. 11: a schematic of a roller as used in the process according to FIG. 10, and

FIG. 12: a schematic of electrodes as obtainable from the process according to FIG. 10.

### DETAILED DESCRIPTION OF THE DRAWINGS

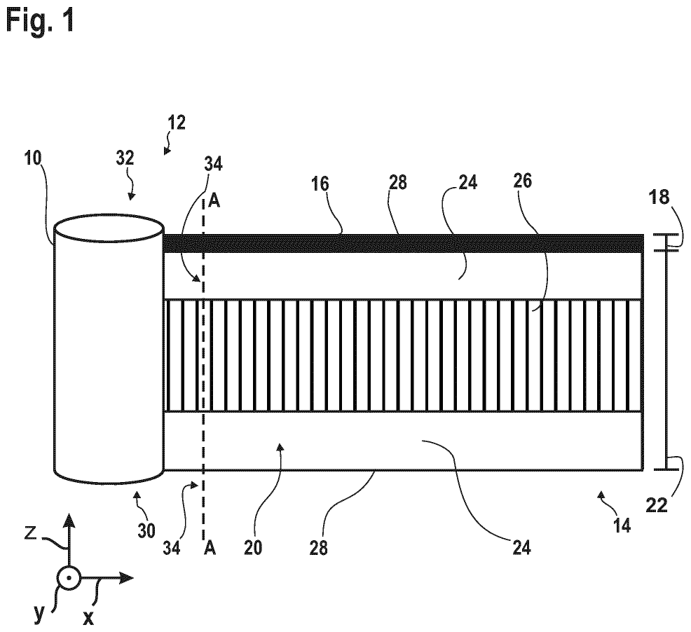

FIG. 1 shows a schematic of an electrode winding 10 of an electrochemical storage cell 12, where the diagram in FIG. 1 shows the electrode winding 10 in partly rolled-up form, such that an electrode 14 is partly apparent.

The electrode winding 10 comprises an electrode 14, a counterelectrode (not shown), and a separator (not shown) disposed between the electrode 14 and the counterelectrode, which electrically insulates the electrode 14 and the counterelectrode from one another.

In principle, the electrode winding 10 could comprise a multitude of electrodes 14 and counterelectrodes, each electrically insulated from one another by a separator.

The electrode 14 comprises an electrically conductive conductor foil 16 formed, for example, from copper or aluminum.

The conductor foil 16, apart from a contact region 18 in which the conductor foil 16 is exposed, is covered by an electrode coating 20. In other words, the electrode coating 20 covers an application zone 22 of the conductor foil 16.

The contact region 18 and the application zone 22 extend in a longitudinal direction x of the electrode winding 10 or electrode 14 over the entire length thereof, but are separated from one another in a widthwise direction z, with the contact region 18 adjoining the application zone 22.

The application zone 22 is divided in turn into outer regions 24 and a central region 26, where the outer regions 24 lie closer to the outer edges 28 in widthwise direction z of the conductor foil 16 than the central region 26.

At the end of the conductor foil 16 in widthwise direction z which is shown at the bottom in FIG. 1 and which is assigned to a bottom side 30 of the electrode winding 10, the outer region 24 there directly adjoins the outer edge 28, while, at the end of the conductor foil 16 in widthwise direction z which is shown at the top in FIG. 1 and which is assigned to a top side 32 of the electrode winding 10, the outer region 24 there is separated from the outer edge 28 there by the contact region 18.

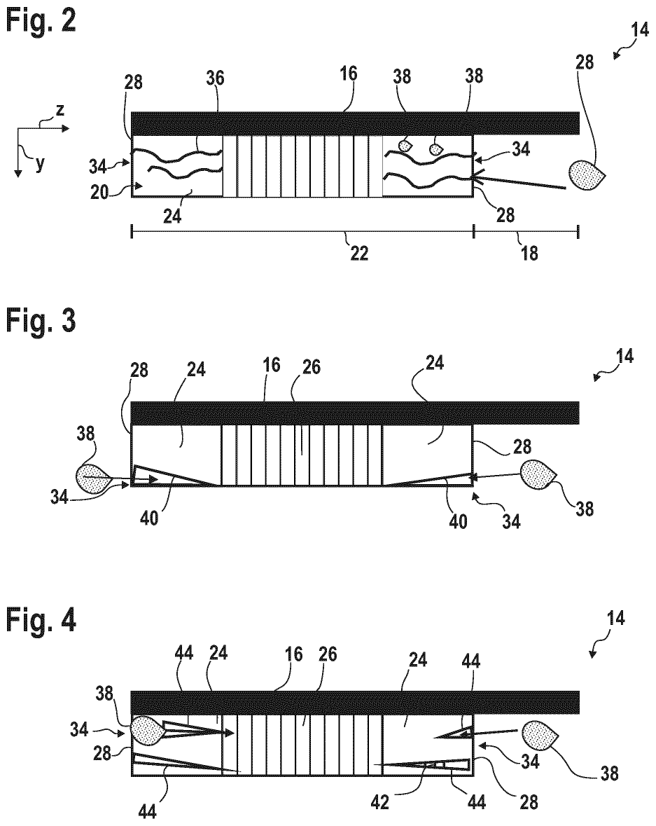

In the installed position of the electrode winding 10 in the electrochemical storage cell 12, the electrode winding 10 is accommodated in a cylindrical storage housing (not shown) which has an upper terminal plate having an introduction opening for filling of the storage housing with an electrolyte 38 (compared to FIG. 2).

In the assembly of the electrochemical storage cell 12, it is particularly important that the electrode winding 10 is permeated as completely and uniformly as possible by the electrolyte 38, since only moistened portions of the electrode winding 10 can take part in charging and discharging operations in the operation of the electrochemical storage cell 12.

For this purpose, the outer regions 24 are configured as electrolyte conduction regions 34 in which the diffusion rate of the electrolyte 38 is higher than in the other parts of the electrode coating 20.

The electrolyte 38 can thus diffuse more quickly within the electrolyte conduction region 34 in the direction of the central region 26, in other words, parallel to widthwise direction z, than outside the electrolyte conduction region 34.

In principle, the electrolyte conduction region 34 may also comprise merely a portion of the outer regions 24 in longitudinal direction x.

FIGS. 2 to 4 each show a schematic section view through the electrode 14 along section plane A-A from FIG. 1, where each of FIGS. 2 to 4 shows an embodiment of the electrode 14.

In the embodiment shown in FIG. 2, the electrode coating 20 comprises, in the electrolyte conduction region 34, a fiber material 36 that extends through the electrolyte conduction region 34 in widthwise direction z.

The fiber material 36 comprises, for example, glass fibers and/or cellulose fibers.

The fiber material 36, owing to interactions between the fiber material 36 and the electrolyte 38, offers a preferred transport pathway for the electrolyte 38 at its surface, as indicated in FIG. 2, and in this way ensures an elevated diffusion rate of the electrolyte 38.

Instead of or in addition to the fiber material 36, the electrode coating 20 may comprise a porous material, for example a carbon material which is absorptive with respect to the electrolyte 38 and in this way assists transportation of the electrolyte 38 through the outer region 24.

In the embodiment shown in FIG. 3, each of the electrolyte conduction regions 34 has depressions 40 that have been introduced, for example, via a structured roller into the electrode coating 20 via a calendering operation, as will be described in detail later.

The depressions 40 have an elongated geometry in widthwise direction z and narrow proceeding from the outer edges 28 toward the central region 26.

The embodiment shown in FIG. 4 shows an electrode 14 that has been obtained by use of a pore former 42.

The pore former 42 is designed to be removed from the electrode coating 20 in the process for production of the electrode 14 to form pores 44, for example by breaking down the pore former 42 at least partly to gaseous compounds after heating to a breakdown temperature.

This results in high variability in relation to the arrangement, size and shape of the pores 44. In particular, it is possible by comparison with the embodiment from FIG. 3 also to create pores 44 not adjacent to an interface of the electrode coating 20.

As apparent in FIG. 4, the pore former 42 may also be merely partly removed such that residues of the pore former 42 still remain in the finished electrode coating 20. However, the pore former 42 has preferably been fully removed in the finished electrode 14.

It will be apparent that the configurations according to FIGS. 2 to 4 may also be combined with one another, for example in that a fiber material 36, a porous material or a pore former is combined with the depressions 40.

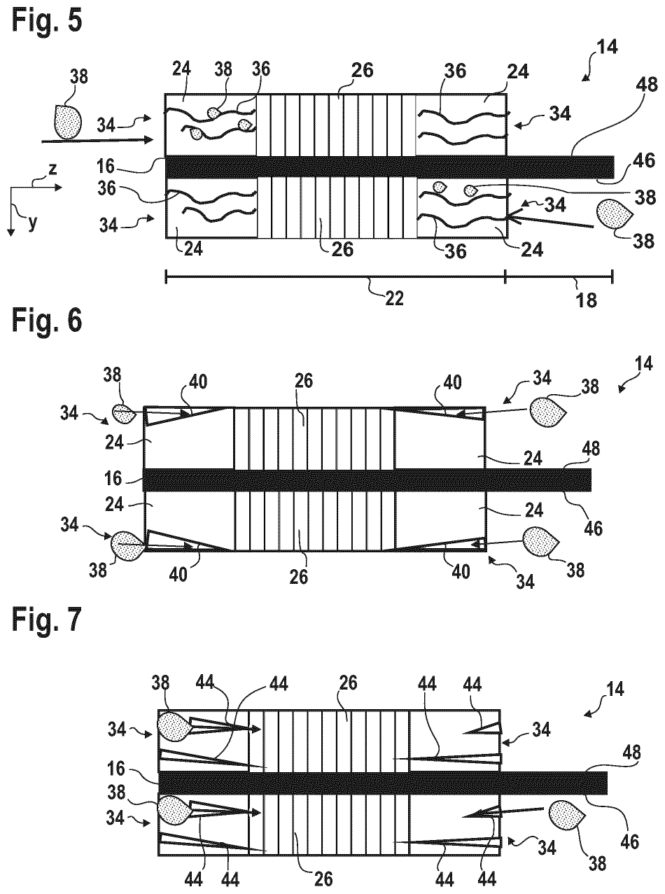

FIGS. 5 to 7 show embodiments of the electrode 14 that are of analogous configuration to the embodiments according to FIGS. 2 to 4. In this case, however, an electrode coating 20 has been applied on both sides of the conductor foil 16, in other words, both on a front side 46 and on a reverse side 48 of the conductor foil 16.

FIG. 5 shows a configuration in which the electrode coatings 20 comprise fiber materials 36 in the outer regions 24, FIG. 6 a configuration in which the electrode coatings 20 have depressions 40, and FIG. 7 an embodiment in which the electrode coating 20 has pores 44 that have been obtained by use of a pore former.

It is fundamentally also possible that the electrode coatings 20 on the front side 46 and on the reverse side 48 of the conductor foil 16 are of different configuration. For example, the electrode coating 20 has a fiber material 36 on the front side 46 of the conductor foil 16, while the electrode coating 20 has depressions 40 on the reverse side 48 of the conductor foil 16.

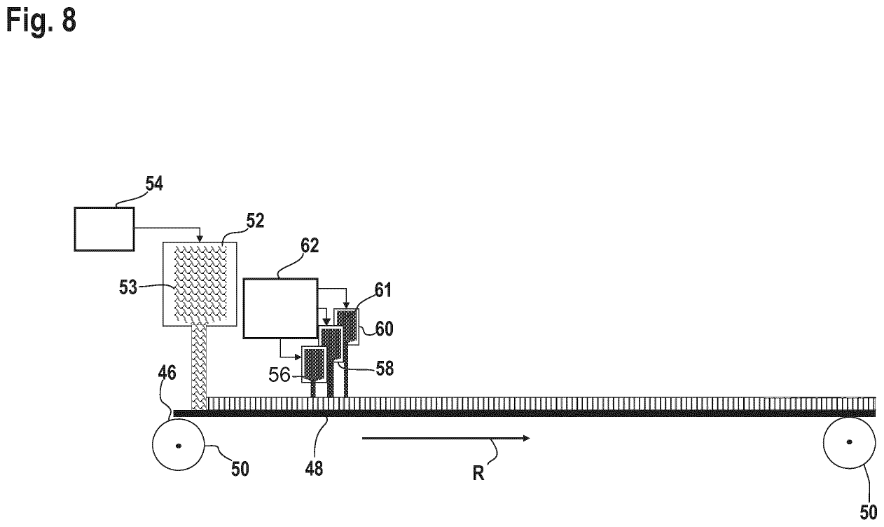

FIG. 8 shows a schematic of a processing step in a process according to the invention for production of the electrode 14 in a first embodiment of the process.

The conductor foil 16 is transported in a processing direction R by transport rollers 50, with the reverse side 48 of the conductor foil 16 in contact with the transport rollers 50. The electrode coating 20 is applied to the front side 46 by a dosage device 52 in the central region 26 of the application zone 22 by application of an electrode mixture 53.

The electrode mixture 53 may differ from the electrode coating 20 in that, for example, additional solvent is present in the electrode mixture 53 in order to improve dosability.

The dosage device 52 is fluidically connected to a feed apparatus 54 that supplies the dosage device 52 with the electrode mixture 53.

There are several additive dosage devices 56, 58 and 60 that are disposed beyond the dosage device 52 in processing direction R and are each fluidically connected to an additive feed apparatus 62.

The additive dosage devices 56 to 60 each cover an outer region 24 of the conductor foil 16 with the electrode coating 20, where the electrode coating 20 in the outer region 24 differs from that in the central region 26. It is accordingly possible for the additive dosage devices 56 to 60 to dose one or more electrode mixtures 61 which differ from that applied by the dosage device 52. For example, the electrode coating 20 has the fiber material 36 in the outer region 24 as described above.

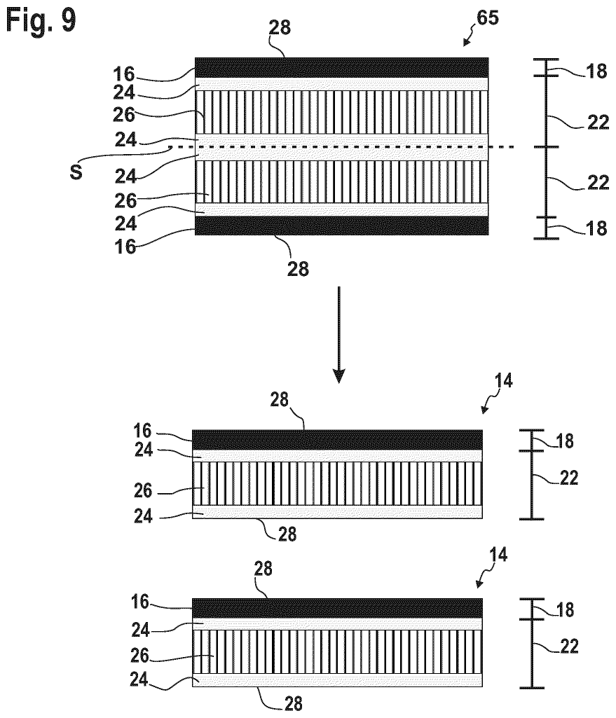

FIG. 9 shows a schematic view of an electrode precursor 65 as obtainable by the process described above. As can be seen, the electrode precursor 65 has two central regions 26 and a total of three outer regions 24, where the outer regions 24 have each been applied to the conductor foil 16 by one of the additive dosage devices 56, 58 and 60.

The electrode precursor 65 is divided, for example cut, in a subsequent processing step along the line S, in order to obtain two electrodes 14.

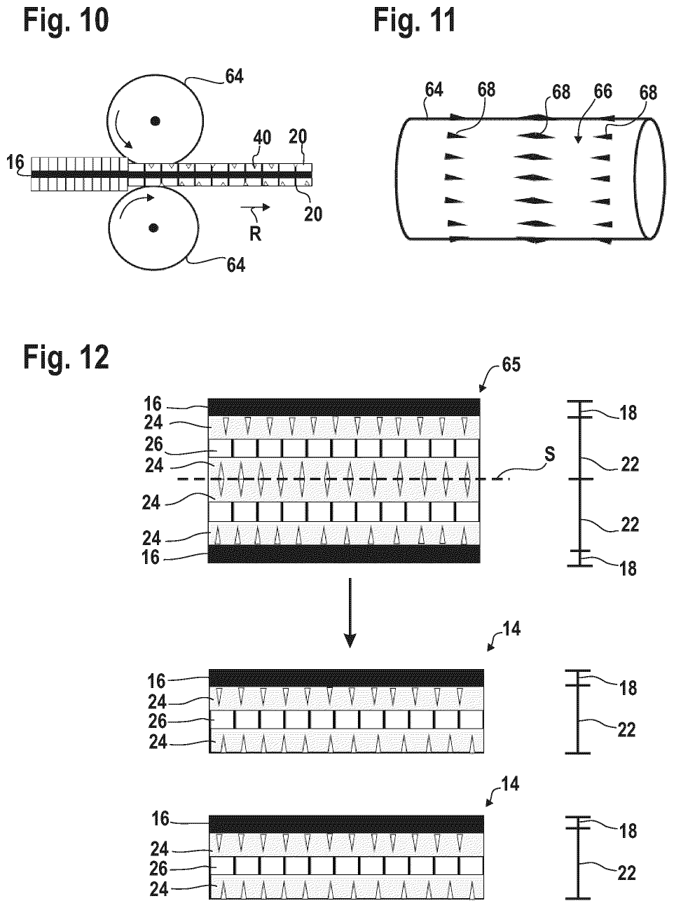

FIG. 10 shows a schematic of a processing step in a second embodiment of the process of the invention.

In this embodiment, the conductor foil 16 has been provided with an electrode coating 20 both on its front side 46 and on its reverse side 48 in an upstream processing step.

Subsequently, the coated conductor foil 16 is run through a roller pair having two rollers 64 in a processing direction R. in order to calendar the electrode coating 20 and simultaneously to provide it with depressions 40.

For this purpose, the two rollers 64 have a structured roller surface 66, as shown in FIG. 11. The structured roller surface 66 has a multitude of elevations 68 that run in concentric rings on the roller 64.

The concentric rings are arranged in such a way that they interact with the electrode coating 20 in the outer regions 24 of the application zone of the conductor foil 16 on calendering, such that the depressions 40 are created in the outer regions 24.

FIG. 12 shows a schematic of an electrode precursor 65 as obtainable in the second embodiment of the process.

By division of the electrode precursor 65 along the line S from FIG. 12 it is again possible to obtain two electrodes 14.

As can be seen, the elevations 68 on the rollers 64 are formed such that the depressions 40 narrow in the direction of the central region 26 and are symmetrical with regard to an axis that runs at right angles to the outer edges 28.

Overall, it is a feature of the electrode 14 that controlled influencing of the electrode coating 20 can provide an optimal compromise between wettability with the electrolyte 38 and the achievable energy density.

1-10. (canceled)

11. An electrode for an electrochemical storage cell, comprising a conductor foil comprising an application zone for an electrode coating, the application zone comprising an outer region and a central region,
wherein the outer region of the application zone lies closer to an outer edge of the conductor foil than the central region; and
wherein the application zone, in the outer region, has at least one electrolyte conduction region in which the diffusion rate of an electrolyte of the electrochemical storage cell is higher than in the application zone outside the electrolyte conduction region.

12. The electrode according to claim 11, wherein the electrode coating comprises a fiber material in the electrolyte conduction region.

13. The electrode according to claim 12, wherein the fiber material comprises glass fibers and/or cellulose fibers.

14. The electrode according to claim 12, wherein the fiber material is electrically conductive.

15. The electrode according to claim 14, wherein the fiber material comprises metallized glass fibers or electrically conductive carbon fibers.

16. The electrode according to claim 11, wherein the electrode coating, in the electrolyte conduction region, comprises a porous material that is absorptive to the electrolyte.

17. The electrode according to claim 16, wherein the porous material comprises a carbon material.

18. The electrode according to claim 16, wherein the porous material is selected from the group consisting of carbon aerogels, mesoporous carbons, microporous carbons, carbons produced by template synthesis, and combinations thereof.

19. The electrode according to claim 11, wherein the electrode coating, in the electrolyte conduction region, comprises one or more depressions.

20. The electrode according to claim 19, wherein at least one depression of the one or more depressions has an outline that narrows in a direction of the central region of the electrode coating.

21. The electrode according to claim 19, wherein at least one depression of the one or more depressions has a symmetrical outline.

22. The electrode according to claim 19, wherein the one or more depressions extend in capillaries from the outer edge in the direction of the central region through the outer region of the electrode coating.

23. The electrode according to claim 11, wherein the electrode coating, in the electrolyte conduction region, comprises a pore former that is at least partly removable from the electrode coating to form one or more pores in the electrode coating.

24. The electrode according to claim 23, wherein the pore former is ammonium bicarbonate.

25. A electrochemical storage cell according to claim 11, comprising at least one electrode.

26. The electrochemical storage cell according to claim 25 that is a lithium ion battery.

27. A process for producing an electrode for an electrochemical storage cell according to claim 11, comprising applying the electrode coating on the application zone of the conductor foil such that the electrode coating comprises different regions that provide different diffusion rates for an electrolyte,
wherein the different regions comprise at least one outer region and one central region.

28. The process according to claim 27, wherein a composition of the electrode coating is varied in the different regions.

29. The process according to claim 27, wherein the applying comprises applying to the at least one outer region a fiber material, a porous material, a pore former, or a mixture thereof, and/or an electrode coating comprising the fiber material, the porous material, the pore former, or the mixture thereof.

30. The process according to claim 27, wherein the electrode coating is calendered with a roller having a structured rolling surface.
